(19) United States
(12) Patent Application Publication
(10) Pub. No.: US 2003/0169482 A1
(43) Pub. Date: Sep. 11, 2003

(54) Hybrid raman-erbium optical amplifiers

(76) Inventors: Alain P. Kung, Holmdel, NJ (US); Mahan Movassaghi, Middletown, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/095,716

(22) Filed: Mar. 11, 2002

(51) Int. Cl. H01S 3/00

(52) U.S. Cl. 359/341.1

(57) ABSTRACT

A high efficiency, low noise, variable gain and low cost amplifier for use in an optical communication system uses a common pumping scheme for simultaneous Raman and erbium amplification in a single module. The invention can be used with any type of fiber which is doped with Erbium and used as a medium for achieving signal amplification due to simultaneous Raman and erbium amplification mechanisms. It can also be extended to any combination of any type of fiber and an erbium doped fiber, where the combination is used to achieve signal amplification due to simultaneous utilization of Raman and erbium amplification mechanisms.

### TECHNICAL FIELD

This invention pertains generally to the field of optical communication, and, in particular, to new designs for optical amplifiers.

### BACKGROUND OF THE INVENTION

Currently, optical amplifiers widely used for optical communications consist of Raman Fiber Amplifiers (RFA) and Erbium Doped Fiber Amplifiers (EDFA), which are implemented in independent modules. In RFA, the amplification is achieved solely by the stimulated Raman amplification process, while in EDFA, the amplification is achieved solely by Erbium amplification process.

Erbium amplification, which is utilized in EDFAs, is highly efficient. This means that most of the pump photons are converted to the signal photons. However, the erbium gain profile from 1530 nm-1620 nm is not flat, and in fact has a substantial negative tilt. Therefore, to achieve amplifiers with flat gain, strong filtering must be used. These filters diminish the amplifier efficiency, degrade the noise performance and add to the complexity and cost of EDFAs. In addition, once built, there is no flexibility of changing gain in EDFAs.

Amplification by stimulated Raman scattering (or simply Raman amplification) utilized in RFAs has much lower efficiency as compared to erbium amplification. In contrast, RFAs generate lower spontaneous emission, leading to a better noise performance. In addition, they can provide flexibility in controlling the gain and its flatness over a wide wavelength range by using several pump wavelengths. However, in high gain RFAs having long length of fibers, multi-path interference (MPI) due to fiber Raleigh back scattering can degrade the overall noise performance of RFAs.

### SUMMARY OF THE INVENTION

The present invention is based on simultaneous utilization of Raman and erbium amplification mechanisms in a single module, and using a common pumping scheme. These new designs render amplifiers with high efficiency, low noise, variable gain and low cost.

In one embodiment of the present invention, a segment of erbium doped fiber is inserted in the optical transmission path such that the erbium doped fiber, as well as a Raman amplifier, receives at least a portion of the output of the same pump laser(s).

In another embodiment of the present invention, any type of fiber that supports Raman amplification is also doped with erbium. Thus, when the fiber receives the pump laser, both Raman and erbium amplifications are generated.

### BRIEF DESCRIPTION OF THE DRAWING

The present invention will be more fully appreciated by consideration of the following detailed description, which should be read in light of the drawing in which:

FIG. 1 is a schematic of one embodiment of a discrete optical amplifier arranged in accordance with the present invention to use a single pumping scheme for both Raman and EDF amplification;

FIG. 2 is a graph illustrating the Erbium and Raman gain of hybrid optical amplifier 100 shown in FIG. 1; and

FIG. 3 is a schematic of another embodiment of the present invention in which any type of fiber, such as a dispersion compensated fiber (DCF), that provides Raman gain, is doped with erbium, and the overall amplifier thus formed is pumped by a single pump arrangement.

### DETAILED DESCRIPTION

In accordance with the present invention, for Raman amplification in the 1500-1620 nm band, a length of fiber is pumped by a single or multiple pumps at 1400-1520 nm; multiple pumps at different wavelengths are used to achieve signal gain in a broader wavelength range. Likewise, pumping erbium doped fibers with pumps at 1400-1520 nm results in the amplification of signals in the 1500-1620 nm band. However, Erbium and Raman amplifications have opposite gain slopes; therefore by combining the two amplification mechanisms, a flat gain is achieved over a wide spectrum in the 1500-1620 nm band, using only one pumping scheme. Also, in accordance with the present invention, amplifiers with adjustable negative tilts can be easily achieved by altering the amount of Erbium doping and/or changing the pump powers in the hybrid erbium-Raman amplifiers.

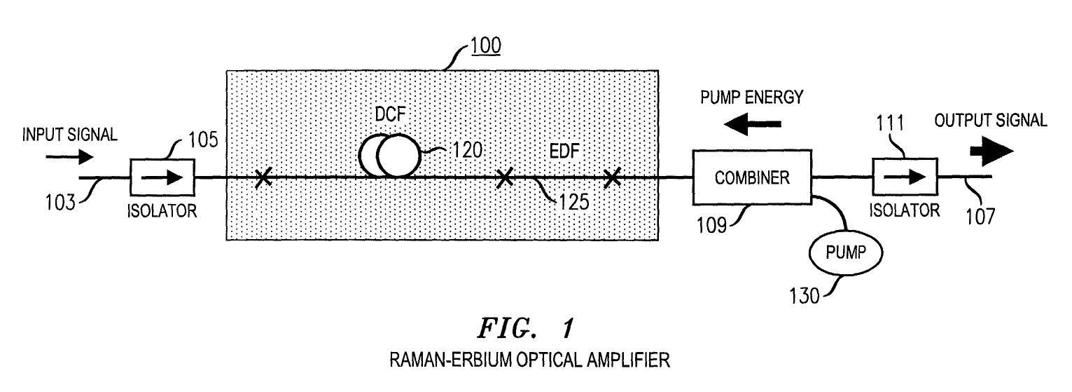

Referring now to FIG. 1, there is shown a schematic of one embodiment of a discrete optical amplifier indicated generally at 100, arranged in accordance with the present invention to use a single pumping scheme for both Raman and EDF amplification. The input signal (which can consist of many wavelengths covering the 1500-1620 band) on input 103, is applied to optical amplifier 100 via an input isolator 105, is amplified in optical amplifier 100 and exits on output 107 after passing through an output isolator 105. A signal-pump combiner 109, such as a wavelength division multiplexer (WDM)), is positioned between the output of optical amplifier 100 and the input of output isolator 105, allows combination of the output of pump 130 with the input signal. Optical amplifier 100 is pumped counter directionally, meaning that the pump energy from pump 130 is applied in the direction toward the input of amplifier 100 and opposite to the direction of the input signal. Dispersion compensating fiber (DCF) 120, which is normally used at the end of each span of a transmission system, receives the input signal from isolator 105 as well as pump energy from pump 130, and is used in the arrangement of FIG. 1 as a gain medium for Raman amplification. For example, DCF 120 can have a length of 5 Km. Coupled to the output end of DCF 120 is a segment or piece of erbium doped fiber (EDF) 125, which is also pumped by pump 130 and provides signal amplification due to erbium amplification process. EDF 125 in FIG. 1 can illustratively be a 1.2 m segment of Lucent MP1480 fiber. The following table lists the pump wavelengths and their powers that can be used for the arrangement shown in FIG. 1:

1444 nm: 133 mW

1457 nm: 111 mW

1470 nm: 160 mW

1489 nm: 187 mW

1508 nm: 135 mW

In this arrangement, the amplifier signal gain is 10 dB, and the input signal has a flat spectrum from 1553-1608 nm with a total power of 10 dBm. Isolator insertion loss is 0.5 dB, and WDM insertion loss for the signal and pump paths are 0.5 dB. By way of comparison, in a conventional design, where EDF 125 is not used, the pump power must be considerably higher to achieve the same gain. As an example, the pump powers that would be required in the design shown in FIG. 1 without EDF 125 are shown in the table below:

1444 nm: 295 mW

1457 nm: 234 mW

1470 nm: 160 mW

1489 nm: 148 mW

1508 nm: 135 mW

It is easy to see that with the arrangement in accordance with the present invention, a considerable (e.g. 25%) saving in total pump power is achieved.

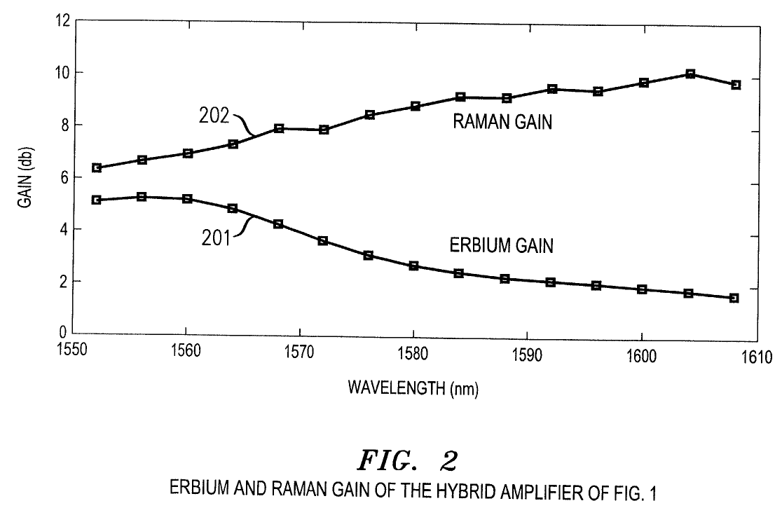

FIG. 2 is a graph illustrating the Erbium and Raman gain of hybrid optical amplifier 100 shown in FIG. 1. This figure shows that the Erbium (plot 201) and Raman (plot 202) amplification mechanisms advantageously have opposite gain tilts.

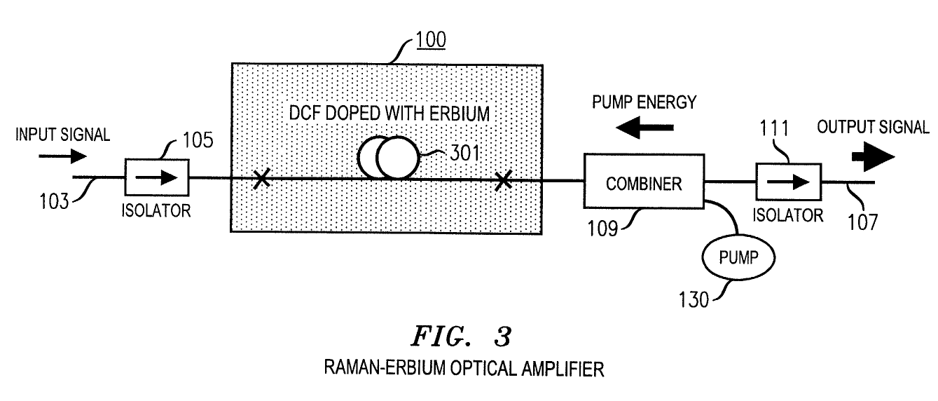

An alternative embodiment of the present invention is illustrated in FIG. 3. In this embodiment, DCF 301 is itself doped with erbium. While various methodologies regard doping will be well understood by persons skilled in the art, the amount of erbium doping can vary, based on the desired balance between erbium and Raman gains. All of the other elements in the arrangement are the same as in FIG. 1, and have the same reference designations. Accordingly, it is seen that in this arrangement, as in the arrangement of FIG. 1, the energy from the same pump 130, when applied to DCF 301, produces both Erbium and Raman amplification. The present invention provides optical amplifiers with higher efficiency, better overall noise performance and lower cost as compared to erbium-doped fiber amplifiers and Raman fiber amplifiers. The invention is applicable to a wide range of systems, including primarily for optical amplification of signals in the 1500-1620 nm range. The arrangement can be used in almost all types of optical network and transport systems, such as ultra long haul, long haul, metro and local access networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. For example, while in the arrangements of FIGS. 1 and 3, pump 130 provides pump energy counter-directionally, it is known that the elements may be rearranged so that the pump provides pump energy codirectionally, i.e., the pump laser is applied to the amplifier in the same direction as the signal being amplified.

1. An optical amplifier arranged to amplify an optical signal, comprising
a first optical fiber segment arranged to provide Raman amplification,
a second optical fiber segment connected to said first segment and arranged to provide erbium amplification,
means for applying said optical signal to said first and second segments, and
a single pump means arranged to supplying optical pump energy to both of said segments.

2. An optical amplifier for amplifying an optical signal, comprising
means for amplifying said optical signal utilizing both Raman amplification and erbium amplification, and
means for pumping said amplifying means from a common laser power source.

3. An optical amplifier for amplifying an optical signal, comprising
first means for amplifying said optical signal utilizing Raman amplification,
second means for amplifying said optical signal utilizing erbium amplification, and
means for pumping both of said first and second means from a common laser power source.

4. A method of amplifying an optical signal in an optical transmission path that includes a Raman amplifier, comprising the steps of:
inserting a segment of erbium doped fiber in the optical transmission path, and
applying at least a portion of the output of at least one pump laser to both the erbium doped fiber and the Raman amplifier.

5. An optical amplifier, comprising
an optical fiber that supports Raman amplification, and
a pump laser for supplying pump energy to said optical fiber,
CHARACTERIZED IN THAT said optical fiber is doped with erbium such that erbium amplification is provided in response to said pump laser.

6. The invention defined in claim 5 wherein said pump laser is arranged to supply pump energy to said optical fiber counter-directionally.

7. The invention defined in claim 5 wherein said pump laser is arranged to supply pump energy to said optical fiber co-directionally.

8. A method for amplifying an optical signal, comprising the step of simultaneous providing Raman and erbium amplification to an optical signal using a common source of pump energy.
